(19) United States
(12) Patent Application Publication
(10) Pub. No.: US 2025/0333558 A1
(43) Pub. Date: Oct. 30, 2025

(54) HIGH HEAT DEFLECTION TEMPERATURE DUCTILE PHOTOPOLYMERIZABLE MATERIAL AND ADDITIVE MANUFACTURING METHODS

(71) Applicant: Ford Global Technologies, LLC, Dearborn, MI (US)

(72) Inventors: Xiaojiang Wang, Saline, MI (US); Ellen Cheng-chi Lee, Ann Arbor, MI (US)

(73) Assignee: Ford Global Technologies, LLC, Dearborn, MI (US)

(21) Appl. No.: 18/647,204

(22) Filed: Apr. 26, 2024

(51) Int. Cl. C08F 283/08; B29C 64/124; B29C 71/02; B29C 71/04; B29K 71/00; B33Y 10/00; B33Y 70/00; B33Y 80/00; C08F 2/50

(52) U.S. Cl. CPC C08F 283/085; B29C 64/124; B29C 71/02; B29C 71/04; B33Y 10/00; B33Y 70/00; B33Y 80/00; C08F 2/50; B29K 2071/12; B29K 2995/0012

(57) ABSTRACT

A method of manufacturing a dual-cured polymer component includes additively manufacturing a green state component from a liquid photopolymerizable material; and dual post-curing the green state component by UV curing and thermal curing such that the dual-cured component is formed. The liquid photopolymerizable material has a composition includes an oligomer with a glass transition temperature greater than about 100° C., a monomer, and a photoinitiator. The thermal curing step is completed in a nitrogen environment to a temperature greater than the glass transition temperature of the oligomer. The dual-cured component has a heat deflection temperature between about 100° C. and 250° C. and an elongation at break between about 5% and 20%.

### FIELD

The present disclosure relates to photopolymer materials and in particular to producing dual-cured components from a photopolymerizable material composition.

### BACKGROUND

The statements in this section merely provide background information related to the present disclosure and may not constitute prior art.

Additive manufacturing (AM) (also referred to as “3D printing”) is a manufacturing technique used to produce parts by sequential deposition and solidification of a material such that a part is gradually assembled. Additive Manufacturing has been widely used in various fields, including the automotive industry, to manufacture complex objects without the need for molds or machining. Vat photopolymerization (VPP) methods such as stereolithography (SLA) and digital light processing (DLP) are AM processes in which liquid photopolymer in a vat is selectively cured by a light source. During the curing process, the photopolymer polymerizes via a free radical reaction when exposed to specific wavelength(s) of light, in particular, ultraviolet (UV) radiation. Curing of the resins ceases once the radiation is removed. Depending on the application, a second curing process may be used to adjust the properties of the AM parts. Post-curing techniques include additional UV curing and thermal curing.

These issues related to AM are addressed by the present disclosure.

### SUMMARY

This section provides a general summary of the disclosure and is not a comprehensive disclosure of its full scope or all of its features.

According to one form of the present disclosure, a photopolymer composition comprises an oligomer having a glass transition temperature greater than about 100° C.; a monomer, wherein the oligomer is soluble in the monomer; and a photoinitiator. After dual-curing, the composition has a heat deflection temperature between about 100° C. and 250° C. and an elongation at break between about 5% and 20%.

In variations of this form, which may be implemented individually or in any combination: the oligomer is at least one of UV-curable polyphenylene ethers (PPE), UV-curable polycarbonates, UV-curable bismaleimide, UV-curable polyamide, UV-curable polyimide or UV-curable polyester; a molecular weight of the oligomer is between about 1,000 g/mol and 10,000 g/mol; wherein the composition has a heat deflection temperature between about 130° C. and 250° C.; the monomer is hydrophobic; the monomer includes mono- , di- , or multifunctional UV-curable functional groups; the monomer includes one or more materials selected from the group comprising styrene, styrene derivatives, and (meth)acrylates; the oligomer is in a range between about 20 wt % and 80 wt %; the monomer is in a range between about 20 wt % and 80 wt %; and the photoinitiator is in a range between about 0.5 wt % and 5 wt %.

According to a second form of the present disclosure, a method of manufacturing a dual-cured polymer component comprises additively manufacturing a green state component from a liquid photopolymerizable material and dual post-curing the green state component by UV curing and thermal curing such that the dual-cured component is formed. The liquid photopolymerizable material has a composition includes an oligomer with a glass transition temperature greater than about 100° C., a monomer, and a photoinitiator. The thermal curing step is completed in a nitrogen environment to a temperature greater than the glass transition temperature of the oligomer. The dual-cured component has a heat deflection temperature between about 100° C. and 250° C. and an elongation at break between about 5% and 20%.

In variations of this form, which may be implemented individually or in any combination: the oligomer is at least one of UV-curable polyphenylene ethers (PPE), UV-curable polycarbonates, UV-curable bismaleimide, UV-curable polyamide, UV-curable polyimide or UV-curable polyester; the monomer includes one or more materials selected from the group comprising styrene, styrene derivatives, and (meth) acrylates; and the oligomer is in a range between about 20 wt % and 80 wt %, and the monomer is in a range between about 20 wt % and 80 wt %.

According to a third form of the present disclosure, a dual-cured component is manufactured by additive manufacturing from a liquid photopolymerizable material. The photopolymerizable material an oligomer having a glass transition temperature greater than about 100° C.; a monomer, wherein the oligomer is soluble in the monomer; and a photoinitiator. After dual-curing, the composition has a heat deflection temperature between about 100° C. and 250° C. and an elongation at break between about 5% and 20%.

In variations of this form, which may be implemented individually or in any combination: the oligomer is at least one of UV-curable polyphenylene ethers (PPE), UV curable polycarbonates, UV-curable bismaleimide, UV-curable polyamide, UV-curable polyimide or UV-curable polyester; the monomer includes one or more materials selected from the group comprising styrene, styrene derivatives, and (meth)acrylates; the monomer includes mono- , di- , or multifunctional UV-curable function groups; the oligomer is in a range between about 20 wt % and 80 wt % of the composition; and the monomer is in a range between about 20 wt % and 80 wt.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a method for manufacturing a dual-cured polymer component by additive manufacturing, according to one aspect of the present disclosure;

FIG. 2 shows a schematic of the UV curing process, according to one aspect of the present disclosure;

FIG. 3 is a set of plots of HDT and ductility data comparing curing methods according to one aspect of the present disclosure;

FIGS. 4-15 are plots of tensile data for photopolymer materials having a composition according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

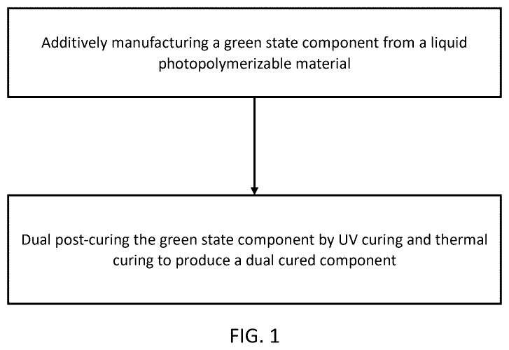

FIG. 1 illustrates a process for manufacturing a dual-cured polymer component by additive manufacturing. First, a green state component is manufactured from a liquid polymerizable material by an additive manufacturing process. The additive manufacturing process is a vat photopolymerization process such as stereolithography or digital light processing. As discussed in more detail below, the photopolymerizable material includes an oligomer, a monomer, and a photoinitiator.

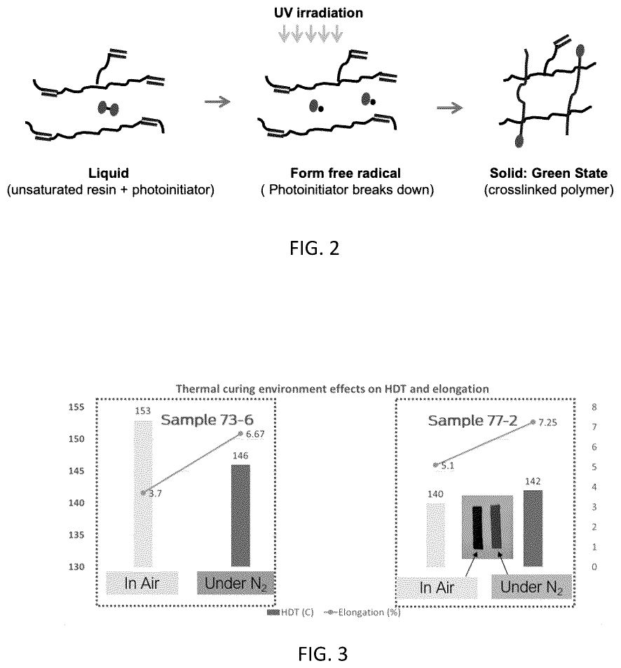

During the AM process, the photopolymerizable material is cured by ultraviolet (UV) light in layers to build up the component. FIG. 2 illustrates the changes in structure as the polymer is cured. The UV light breaks down the photoinitiator. The resulting free radicals induce a cross-linked polymerization and create a solid green state component.

Next, the green state component is dual post-cured by both UV curing and thermal curing to produce the dual-cured component. In one form, the green state component is UV cured for 2 hours. The thermal curing step is performed in a nitrogen environment to a temperature greater than a glass transition temperature of the oligomer. In particular, the thermal curing is performed at a temperature greater than 100° C. In one form, the thermal curing includes heating the UV-cured component to a temperature of 220° C. for 16 hours. Following the thermal curing, the cross-linking of the polymer is completed, and the physical and mechanical properties of the component are developed.

For the purposes of the present disclosure, the component which has been both UV-cured and thermally cured is referred to herein as ‘dual-cured’. The dual-cured component has a heat deflection temperature between about 100° C. and 250° C. and an elongation at break between about 5% and 20%. The properties are discussed in more detail below.

Returning to the composition of the photopolymerizable material, as stated above, the material includes an oligomer, a monomer, and a photoinitiator. In one form, the oligomer content is in a range between about 20 wt. % to about 80 wt. % of the photopolymerizable material composition; the monomer content is in a range between about 20 wt. % to about 80 wt. %; and the photoinitiator content is in a range between about 0.5 wt. % to about 5 wt. %, up to a maximum weight percent of 100%.

The oligomer plays the largest role in determining the properties of the final product. The oligomer must be soluble in the monomer and UV-curable. Because of the needs of the additive manufacturing process, the photopolymerizable material must be a liquid at room temperature when the oligomer is dissolved in the monomer. In addition, the oligomer has a glass transition temperature greater than about 100° C. In one form, the oligomer has an elongation at break greater than about 5% if self-polymerized. In one form, the molecular weight of the oligomer is between about 1,000 and 10,000 g/mol. The oligomer includes one or more of UV-curable polyphenylene ethers (PPE), UV-curable polycarbonates, UV-curable bismaleimide, UV-curable polyamide, UV-curable polyimide, and UV-curable polyester. However, other oligomer materials may be utilized if they have the described properties.

The monomer provides functional groups for the polymerization process and a medium to dissolve the oligomer. If a mixture of monomers is used, the oligomer is soluble in at least one monomer, while other monomers provide additional properties. The monomer has low volatility, high ductility and HDT and includes one or more of mono- , di- , or multifunctional UV curable functional groups. More specifically, the monomer includes one or more of styrene, styrene derivatives, acrylates, and meth-acrylates. In one form, the monomer is hydrophobic which results in a water stable composition.

The photoinitiator is included to start the curing process of the oligomer and monomer when exposed to UV radiation. The UV light breaks the photoinitiator into free radicals which initiate the cross-linking process. In one form, the photoinitiator is Ethyl (2,4,6-trimethylbenzoyl) phenylphosphinate or phenylbis(2,4,6-trimethylbenzoyl) phosphineoxide.

In one form, the photopolymerizable composition also includes additives added to modify the properties. The additives could be graphene, cellulose, carbon black, or carbon nanotubes.

Table 1 below includes examples of compositions according to the present disclosure which have been cured in different conditions and tested to determine the resulting HDT and elongation at break. Each of the examples includes UV-curable solid PPE as an oligomer, and styrene, an acrylate (CD595) and a methacrylate (AOMA™) as monomers. 1% of a photoinitiator was also included. The examples were UV-cured for 2 hours.

TABLE 1

| | | | | | | | | | | Cured Property | |
|---|---|---|---|---|---|---|---|---|---|---|---|
| | | Composition | | | | UV | Thermal Cure | | | | Elongation |
| | Sample | (weight, by part) | | | | Cure | Temp. | | | HDT | at Break |
| Example | ID | SA9000 | AOMA | Styrene | CD595 | Time | (° C.) | Time | Environment | (° C.) | (%) |
| 1 | 73-6 | 50 | | 50 | | 2 h | 220 | 16 | Air | 153 | 3.7 |
| 2 | 73-6 | 50 | | 50 | | 2 h | — | — | — | 115 | 3.3 |
| 3 | 73-6 | 50 | | 50 | | 2 h | 220 | 16 | Nitrogen | 146 | 6.7 |
| 4 | 77-2 | 40 | | 40 | 20 | 2 h | 220 | 16 | Air | 140 | 5.1 |
| 5 | 77-2 | 40 | | 40 | 20 | 2 h | 220 | 16 | Nitrogen | 142 | 7.3 |
| 6 | 187-5 | 40 | 20 | 20 | 20 | 2 h | 220 | 16 | Nitrogen | 142 | 12.2 |
| 7 | 187-6 | 50 | 16.7 | 16.7 | 16.6 | 2 h | 220 | 16 | Nitrogen | 155 | 9 |
| 8 | 185-2 | 50 | 50 | | | 2 h | 220 | 16 | Nitrogen | 121 | 7.3 |
| 9 | 188-3 | 50 | 33 | | 17 | 2 h | 220 | 16 | Nitrogen | 146 | 10.2 |
| 10 | 187-5 | 40 | 20 | 20 | 20 | 2 h | 220 | 16 | Nitrogen | 123 | 9.9 |
| 11 | 187-6 | 50 | 16.7 | 16.7 | 16.6 | 2 h | 220 | 16 | Nitrogen | 142 | 8.3 |
| 12 | 185-2 | 50 | 50 | | | 2 h | 220 | 16 | Nitrogen | 116 | 9 |
| 13 | 188-3 | 50 | 33 | | 17 | 2 h | 220 | 16 | Nitrogen | 131 | 13.5 |

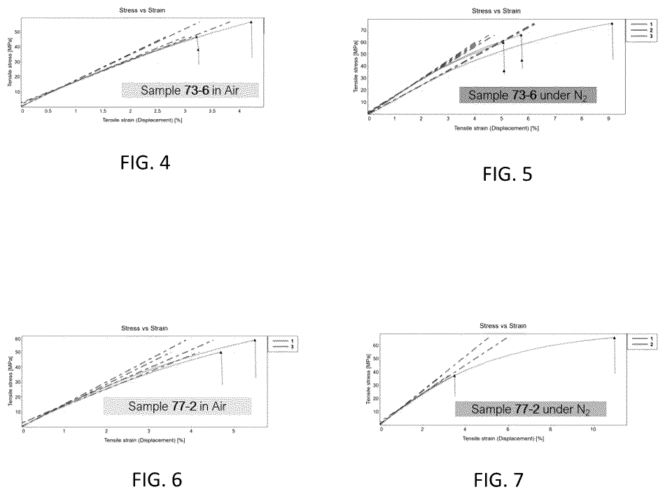

FIG. 3 is a plot of the testing results for Examples 1 and 3 and Examples 4 and 5. Examples 3 and 5 were cured in a nitrogen environment and demonstrate increased elongation at break in comparison to Examples 1 and 4 cured in air, illustrating the effect of thermal curing in a nitrogen environment vs air. FIGS. 4-7 are plots of tensile testing results for Examples 1 and 3-5.

Comparing Example 3 and Example 2 shows that the dual-cured component of Example 3 has increased HDT compared to Example 2 which was only UV-cured.

Examples 3 and 5-13 are dual-cured samples of compositions according to the present disclosure. Each example has a heat deflection temperature between about 100° C. and 250° C. and an elongation at break between about 5% and 20%.

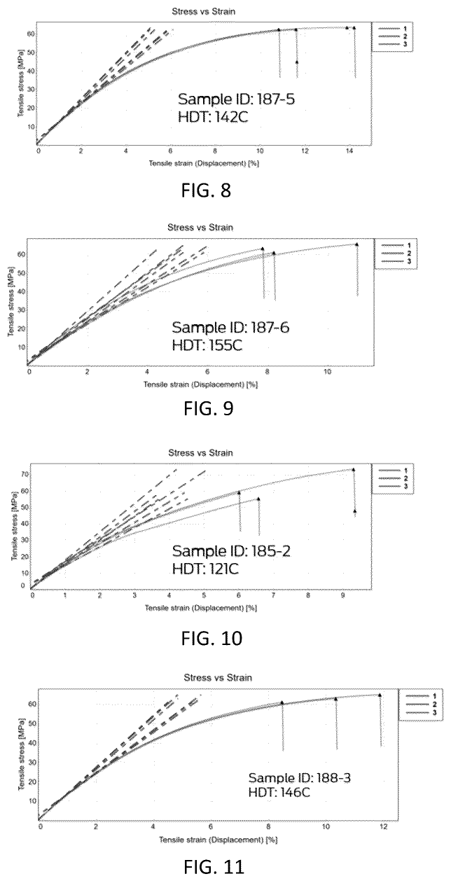

Samples of Examples 1-9 were produced by solution casting for testing of the composition and curing methods. FIGS. 8-11 are plots of tensile testing results for Examples 6-9.

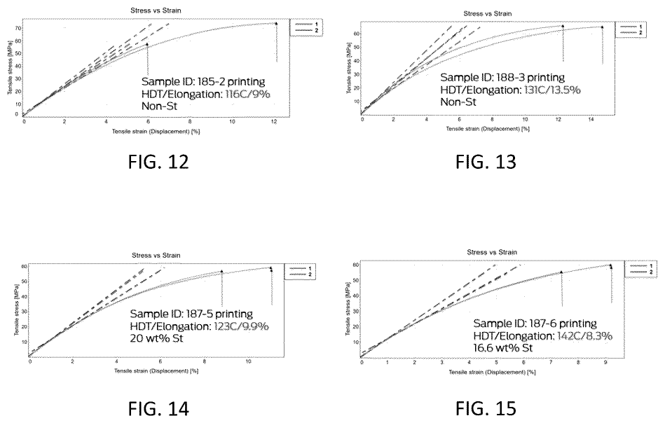

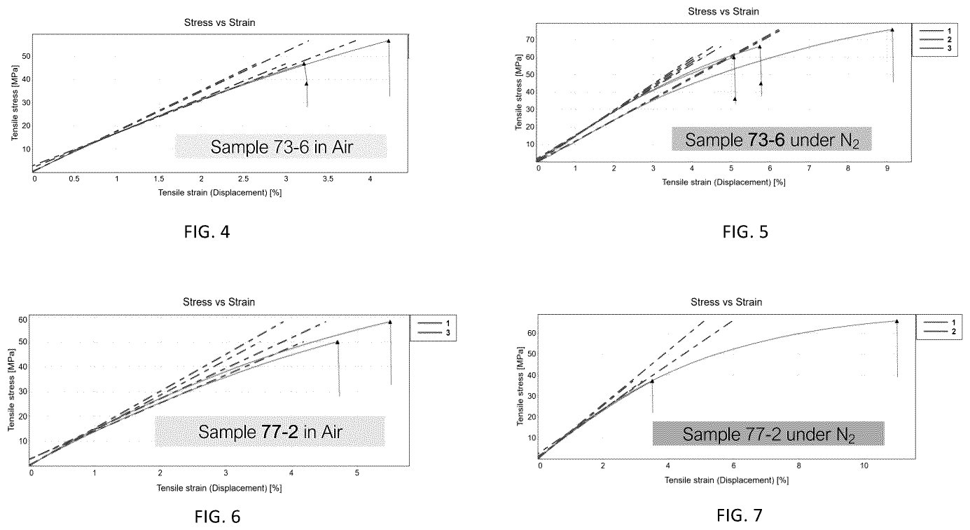

FIGS. 12-15 are plots of tensile testing results for Examples 10-13. Samples of Examples 10-13 were produced by 3D printing on a digital light processing (DLP) printer. It can be seen that the HDT and ductility are not negatively affected by the process of 3D printing.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A photopolymer composition comprising:
an oligomer having a glass transition temperature greater than about 100° C.;
a monomer, wherein the oligomer is soluble in the monomer; and
a photoinitiator,
wherein, after dual-curing, the composition having a heat deflection temperature between about 100° C. and 250° C. and an elongation at break between about 5% and 20%.

2. The photopolymer composition of claim 1, wherein the oligomer is at least one of UV-curable polyphenylene ethers (PPE), UV-curable polycarbonates, UV-curable bismaleimide, UV-curable polyamide, UV-curable polyimide or UV-curable polyester.

3. The photopolymer composition of claim 1, wherein a molecular weight of the oligomer is between about 1,000 g/mol and 10,000 g/mol.

4. The photopolymer composition of claim 1, wherein the composition has a heat deflection temperature between about 130° C. and 250° C.

5. The photopolymer composition of claim 1, wherein the monomer is hydrophobic.

6. The photopolymer composition of claim 1, wherein the monomer includes mono- , di- , or multifunctional UV-curable functional groups.

7. The photopolymer composition of claim 1, wherein the monomer includes one or more materials selected from the group comprising styrene, styrene derivatives, acrylates, and (meth)acrylates.

8. The photopolymer composition of claim 1, wherein the oligomer is in a range between about 20 wt % and 80 wt %.

9. The photopolymer composition of claim 1, wherein the monomer is in a range between about 20 wt % and 80 wt %.

10. The photopolymer composition of claim 1, wherein the photoinitiator is in a range between about 0.5 wt % and 5 wt %.

11. A method of manufacturing a dual-cured polymer component, the method comprising;
additively manufacturing a green state component from a liquid photopolymerizable material, the liquid photopolymerizable material having a composition comprising an oligomer having a glass transition temperature greater than about 100° C., a monomer, and a photoinitiator; and
dual post-curing the green state component by UV curing and thermal curing such that the dual-cured component is formed, the thermal curing being performed in a nitrogen environment to a temperature greater than the glass transition temperature of the oligomer,
wherein the dual-cured component has a heat deflection temperature between about 100° C. and 250° C. and an elongation at break between about 5% and 20%.

12. The method of claim 11, wherein the oligomer is at least one of UV-curable polyphenylene ethers (PPE), UV-curable polycarbonates, UV-curable bismaleimide, UV-curable polyamide, UV-curable polyimide or UV-curable polyester.

13. The method of claim 11, wherein the monomer includes one or more materials selected from the group comprising styrene, styrene derivatives, acrylates and (meth)acrylates.

14. The method of claim 11, wherein the oligomer is in a range between about 20 wt % and 80 wt %, and the monomer is in a range between about 20 wt % and 80 wt %.

15. A dual-cured component manufactured by additive manufacturing from a liquid photopolymerizable material, the photopolymerizable material comprising:
an oligomer having a glass transition temperature greater than about 100° C.;
a monomer, wherein the oligomer is soluble in the monomer; and
a photoinitiator,
wherein the dual-cured component has a heat deflection temperature between about 100° C. and 250° C. and an elongation at break between about 5% and 20%.

16. The component of claim 15, wherein the oligomer is at least one of UV-curable polyphenylene ethers (PPE), UV curable polycarbonates, UV-curable bismaleimide, UV-curable polyamide, UV-curable polyimide or UV-curable polyester.

17. The component of claim 15, wherein the monomer includes one or more materials selected from the group comprising styrene, styrene derivatives, acrylates and (meth)acrylates.

18. The component of claim 15, wherein the monomer includes mono- , di- , or multifunctional UV-curable function groups.

19. The component of claim 15, wherein the oligomer is in a range between about 20 wt % and 80 wt %.

20. The component of claim 15, wherein the monomer is in a range between about 20 wt % and 80 wt.
